(19) United States
(12) Patent Application Publication
(10) Pub. No.: US 2011/0131847 A1
(43) Pub. Date: Jun. 9, 2011

(54) Art display system and method

(76) Inventor: Brian Acworth, Centerport, NY (US)

(21) Appl. No.: 12/802,486

(22) Filed: Jun. 7, 2010

Related U.S. Application Data
(63) Continuation-in-part of application No. 12/653,126, filed on Dec. 8, 2009.

(30) Foreign Application Priority Data
Feb. 11, 2010 (GB) 1002334.9

(51) Int. Cl. G09F 9/30; G09F 13/04; B23P 11/00

(52) U.S. Cl. 40/463; 40/554; 29/428

(57) ABSTRACT

A system for displaying illuminated art which includes an electrical/frame kit with interchangeable components and a flexible media imprinted with artwork which combine for display of the artwork as on a table lamp or hanging lamp. The media is constructed out of a flexible sheet of plastic or a fabric-plastic laminate which is formed into a cylindrical or oval shape or other cylindrical shape. The framework for supporting the illuminated media includes a slot provided in a central ring to accommodate a light source of an electrical assembly, whereby the light source is prepared so that the user assembles it without having to wire the electrical components and wires. A digital library is set up where museums or other institutions or businesses can upload images of selected artworks formatted to be printed on the flexible sheets of the media.

### RELATED APPLICATIONS

This application is a continuation-in-part of application Ser. No. 12/653,126, filed Dec. 8, 2009. Applicant claims priority under 35 U.S.C. §120 therefrom. Applicant also claims priority under 35 U.S.C. §119 from United Kingdom application number 1002334.9, filed Feb. 11, 2010.

### FIELD OF THE INVENTION

The present invention relates to a method displaying art in an illuminated display.

### BACKGROUND OF THE INVENTION

Museum gift shops often have items for purchase related to their purpose. With the advent of wide format high resolution digital printers and the availability of art images on digital media, low volume translucent reproductions of art or designs for illuminated display are feasible.

Visitors to museums are varied. Some arrive by car and would therefore be able to purchase a bulky item; place it in a car, and take it home. Others arrive by public transportation such as a subway or bus, and therefore their carrying capability is limited. Still others may arrive by rental car while on a distant trip; but they must return by air thereby limiting the bulk and fragility of their purchase at a museum shop. For some, purchasing a compactly packaged kit consisting of a customer selected electric/frame kit and a customer selected art image packaged separately but sold in combination for home assembly is ideal; others would balk at purchasing anything that would require even the minimum of assembly involvement. Customer order fulfillment by purchase, purchase of an assembled unit at point of purchase or by shipment of an assembled unit to their home, assembled by the museum or by the company per museum order, should all be accommodated by the museum shop. Also, storage space for stock is at a premium at a typical museum shop and this is a factor favoring inventory of compactly packaged kits that can be flexibly combined.

The prior art reveals many types of illuminated display units. Some are for the display of two dimensional art reproductions. A sampling of such patents follows. For example, the lamp shade of Lewis, U.S. Pat. No. 2,660,317, has a fenestration on its surface and a recessed plate for accepting an art object in sheet form to be illuminated indirectly by reflected light from the lamp. Buzick's picture display panel for lamp shades (U.S. Pat. No. 2,177,204) is primarily for display of black and white pictures printed on translucent paper by transmitted light. Morgen's lightbox lampshade (U.S. Pat. No. 6,821,002) provides uniform illumination on its surface for viewing photographic slides placed on its surface. The U.S. patent of Swanson (U.S. Pat. No. 7,347,593) relates to a Giclee printed lamp shade that is capable of displaying a high resolution art reproduction made from a digital image file using a process for adhering an image printed on canvas to the surface of an existing lamp shade, where the printing in Swanson occurs before the canvas is adhesively secured to the base lamp shade.

Many other patents in the prior art deal with the bulkiness of lampshades. They relate to knockdown, collapsible, or foldable lamp shades which can be shipped or stored compactly and then assembled and used on a lamp. Four such U.S. patents and one US patent application are identified here as a sampling of the field. They are U.S. Pat. No. 3,742,210 of Chapman, U.S. Pat. No. 3,787,676 of Korach, U.S. Pat. No. 4,075,684 of Witz, U.S. Pat. No. 4,354,222 of Gall, and U.S. patent application US 2006/0239012 of Bin. None of these relate directly to the display of art.

Indeed, while the prior art teaches several approaches to the design of illuminated display units for displaying art or storing lampshade frames more compactly, none describe an efficient method to display art or any selected image in the home or elsewhere on an illuminated display unit that is compatible with the operation of a museum gift shop or other institution or business establishment.

### OBJECTS OF THE INVENTION

The main object of this invention is to create an efficient business model that serves the need of museum gift shops and their customers so that art may be enjoyed in the home after it is appreciated in the museum. Other venues besides museum gift shops can be similarly served. Along the way, a viable manufacturing business is also created.

Another object is to provide illuminated art display units from a set of interchangeable components capable of constructing illuminated art display units from a plurality of presentation modes, such as free standing, pedestal mounted, ceiling suspended and the like.

Other objects which become apparent from the following description of the present invention.

### SUMMARY OF THE INVENTION

Museums and particularly museum gift shops have been identified as potential initial participants in the utilization of this invention and display by a purchaser in a home is anticipated throughout this narrative but this should be interpreted only as an example and should not be regarded as limiting the scope of the usefulness of the invention. Almost any institution or business could be a potential initial participant and the display unit could be located anywhere for any purpose.

The vehicle for such a method is an illuminated display unit (IDU) for displaying two dimensional high quality reproductions of art work. The concept for the IDU of this invention differs from that of an ordinary lamp and lampshade in that the display of the art image is an integral part of the lighting unit. Low manufacturing cost, compact storage in kit form, and ease of customer assembly are the hallmarks of the IDU. Although the manufactured frame parts are standardized in a range of sizes to minimize cost, the technique for creating the art sheets which are illuminated permits a wide range of image heights to be accommodated by the frame parts which are standardized. The IDU can be used as a table-top unit like an ordinary table lamp, or the very same unit can also be suspended by an integral electric pulley cord. As a table-top unit, the same frame elements can be used to illuminate and display a variety of art reproductions just by changing one art sheet for another. Since the electrical parts are provided as a completely pre-wired electrical set in the kit and a unique slot is provided to insert the electric assembly into the frame, no electrical experience nor tools are used in the customer assembly of the IDU kit.

Basically, in the preferred embodiment, the lamp socket is an AC powered lamp socket, which is secured to the hub of the support frame part with a fastener, such as a hand-tightened nut; then the art sheet is formed into an ellipse, or other shape, then simply attached to or secured around the support frame member and a second plain frame member is attached at the top. For table-top use, the support frame is at the bottom, and the plain frame is at the top of the art sheet. For suspended use, this is reversed. If for table top use with a pedestal, a tube and a second support frame to serve as a base (or a modified base) is added. In an alternate embodiment, the light source may be a light emitting diode (LED) light source or other light source, such as a compact fluorescent light source, and may be powered by a DC power source, such as, for example, a battery.

The production technique of printing the art sheet by high resolution wide-format ink jet printers is well known, but while the material of the art sheet may be a flexible translucent or transparent sheet of plastic, such as styrene, for example, in a preferred embodiment in this use the material of the art sheet is custom manufactured for the IDU application to insure heat resistance, archival type ink acceptance, and a translucent appearance, in a pre-laminated fabric exterior surface, which also provides rigidity once curved into a shape around the frame members. This exterior fabric of the pre-laminated art sheet is laminated to plastic prior to printing to insure stability of the printed image and simplified production. While any printer capable of printing an image upon a flexible translucent or transparent sheet of plastic may be used, in a preferred embodiment wide format printers may be used, such as printers made by such companies as Epson, Canon, Hewlett Packard, Xerox and others which offer widths from 24 inches to 72 inches. For example, the 8-color 54 inch wide Epson Stylus GS6000 is one such printer that can be used to print art sheets.

The IDU of this invention will be described as having an oval crossectional cylindrical shape as the display surface of the art sheet. The frame members are fixed sizes. For instance, a 24 inch wide art sheet formed around the appropriate size frame will fit on a frame with a major oval diameter of approximately 9.2 inches and a minor diameter of about 5.7 inches. Provision is made for the art sheet and the frames to be permanently joined if required. The use of art sheets cut into wider strips would permit IDU's of different larger or smaller standard sizes. Using this type of printing method the circumference of the IDU display is fixed by the width of the sheet being used, but the height of the art sheet can be easily varied since this is determined by the how the sheet is programmed to be printed and cut apart after printing for use in the fixture. In this way, actual art sheet heights can practically be infinitely varied.

The business model for this invention presupposes that a “company” is formed to produce art sheets and frame/electrical kits for IDU's that would interface with a variety of museum shops around the country or around the world. The company has a computer system which will communicate between the company and its customers. The computer system includes a microprocessor and a database for receiving and storing data. The database has data processing systems by which the company and respective gift shops communicate via a browser controlling communications over a network via a server, images, plus any text required, formatted for printing by the company. All communications can be handled via internet for receiving orders, payment, and developing image files. In addition, tangible media forms such as DVD's, portable hard drives, scanned documents, memory sticks, or diskettes can be used instead. Another option is to transfer files via internet connected or direct cell phone communications. Products can be shipped by common carrier services. When a museum gift shop gears up for support of a special museum exhibit, images related to the exhibit can be produced. The initial order for a new image must first create an Image Art Unit (IAU) file with the exact edited digital representation of each image and any text required to be printed on an art sheet. This is what will drive the wide format printer. The formatting from the source Exhibit Art Image file can either be done by the company (with instructions from the museum), or it can be performed by museum personnel using editing software supplied by the company. In all cases the museum descriptions of the art are printed separately and included with the IDU, as are instructions for customer assembly.

The company uses pricing software which prices each art sheet corresponding to each desired IAU. Part of the pricing algorithm is based on the height and width of the particular resulting art sheet reflecting the actual substrate material and printing cost. Another pricing aspect may be the ink cost for a particular art sheet reflecting the actual digital color and color density information of each pixel of the art reproduction. Other aspects of pricing may include printer set-up charges and/or amortized formatting charges related to volume ordered. Once the pricing is set for the images, this is relayed to the museum gift shop. Based on demand estimates an initial order is placed for both the various art sheets as well as for IDU frame/electrical kits selected by the museum. The company will then schedule production and fulfill the initial order for art sheets and IDU's from the museum shop. Subsequent orders for IDU's and/or art sheets will be filled as required.

At the museum gift shop, customer order fulfillment can be accomplished in a number of ways. Customers may purchase pre-packaged art sheets and IDU kits, pay for them and leave. They may request an assembled IDU. This can be handled by on-demand assembly at the museum shop or from stock pre-assembled by the museum, or the museums shop can order the unit to be assembled by the company and shipped to the address given by the customer. Assembly for stock can be performed at the museum shop during slack periods.

In an alternate embodiment, a support frame kit including two plain support frames, 3 or 4 or more legs, a lamp socket support disc, an assembled electric kit and an art sheet are provided as a complete kit ready to assemble an illuminated display unit (IDU) of this invention. No tools are required for assembly. The packaging is more compact than the previous embodiments incorporating a one-piece molded support frame which included three or four or more legs and a lamp socket support disc.

The support frame is assembled by inserting the ends of each leg into a mating feature of either one of the plain frames on one end and on a similar mating feature on the socket support disc in the center. Although the mating features are illustrated in one embodiment as a male and a female dovetail joint, other molded simple sliding and/or snap fit joining features, as are commonly known for joining pieces of an item can be used instead. Marks are provided on the rims of the frames to correctly align the flexible art sheet with the frame.

In one design, the tapered dovetail slots on the legs have the open end in the same direction at the end of each leg. The matching tapered dovetail lugs on the support frame and lamp socket support disc face alternately in opposite directions around their circumferences. Assembly is achieved by sliding the leg slots onto the hub and rim lugs. Therefore it is possible to install the legs either way up (by turning the legs over and moving each leg around the circumference of the support frame to the next set of lugs), depending on which leg position, up or down, is required for the model being assembled. There may be two sets of lugs on the lamp support disc at two different radii or that may be projecting incorporated into one of the rims to compensate for different radii, so that a range of support frames can be accommodated by the same leg length.

In a preferred alternate embodiment, the opposite distal ends of legs connecting the support frame to the central hub have attachment extensions which mate with slots or holes associated with the support frame at one end and with the central hub light source support disc at the other end. In a further alternate embodiment the legs are “V-shaped”. The V-shaped legs may be symmetrical or, in a further alternate embodiment may be asymmetrical, to enable the support of the unit to be spread farther apart. The extensions are inserted into and through slots or holes in the support frame and the hub, such as the lamp support disc. As these extensions are pushed in toward the step region, molded cantilevered tongues are compressed until they again snap out locking extensions in the slots or holes. The “Vee” shape of the legs is preferably asymmetric to place the vertex closer to the edge than to the lamp support disc at the center, which provides better stability. The cantilevered tip of each tongue is spring loaded, so that it compresses as the tongue is inserted into the leg attachment slot/hole and decompresses outward when through the slot/hole, thereby locking the legs in place in the respective slots/holes in the support frame at one end and in the lamp support disc at the other end.

The configurations for the various models are as follows:
For the tabletop model

Bottom: Assembled support frame faces up, legs down

Top: Plain support frame faces down
For the hanging model

Bottom: Plain support frame faces up

Top: Assembled support frame faces down, legs down
For the pedestal model

Bottom: Assembled support frame faces up, legs up

Top: Plain support frame faces down

Base: Support frame faces down, legs up

Note that these attached configurations are only possible if the support frame is not molded in one piece but in separate pieces for customer assembly as described herein.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of an assembled IDU in use on a table top.

FIG. 1A is a perspective view of an assembled IDU with a pedestal using a second support frame at the base in use on a table top.

FIG. 1B is a perspective view of an assembled IDU with a base using a modified base in use on a table top.

FIG. 2 is a perspective view of an assembled IDU suspended by pulley cord.

FIGS. 3A and 3B are top plan views of the two part frame set showing the plain frame as well as the support frame if molded in one piece, incorporating, in this case with 4 legs.

FIG. 4 is a crossection detail of the art sheet support edge of each frame member showing the edge of the art sheet abutting a layer of attachment tape

FIG. 5 is a plan view of the pre-wired electrical kit that is part of the IDU kit. (in the case illustrated this is for a table top unit and incorporates a dimmer Alternative electrical kits will be available, including a kit with a pulley cord for suspended units.)

FIG. 5A is a plan view of an alternative electrical kit for a table top unit with a pedestal that will use a second support frame as a base.

FIG. 5B is a plan view of an alternative electrical kit for a table top unit with a pedestal using a modified base.

FIG. 6 is a side view crossection of an assembled tabled table top IDU taken along the major diameter of the oval shape.

FIG. 6A is a side view crossection of an assembled table top IDU of an alternate embodiment using modified frame support edges.

FIG. 6B is a side crossection detail of a modified edge as shown in FIG. 6A.

FIG. 6C is a side view cross section of an assembled table top IDU with a pedestal using a second support frame member as a base.

FIG. 6D is a side view cross section of an assembled table top IDU with a pedestal using a modified base.

FIG. 7 is a perspective schematic view showing a continuous portion of art sheet material merging from a printer with a variety of art works printed on art sheet sections (prior to cutting apart for each IDU).

FIG. 8 is a flow chart describing the assembly of an IDU formed with a one piece support frame and a plain frame.

FIG. 9 is a flow chart of the initial order set-up supporting a new museum exhibit.

FIG. 9A is a block diagram reflecting the hardware and network entities involved in implementing the flow chart of FIG. 9.

FIG. 10 is a flow chart depicting the various customer fulfillment options at a museum gift shop.

FIG. 11 is a schematic top view of four different designs of IDU shapes each in which will have the same circumference for use with the same width art sheet.

FIG. 12 is a perspective view of the separate parts of a frame kit of one type of alternate embodiment, in this case with four legs and a hub with two sets of four attachment lugs to accommodate frames with two different radii, such as, for example, an ellipse as compared to a circular frame, such as a rim. In this case, either of the rims frames may be used for the support frame since both incorporate attachment lugs.

FIG. 13 is a perspective view of an assembled support frame using parts from the frame kit of FIG. 12.

FIG. 14 is a perspective view of a single leg from the frame kit using frame using parts from the frame kit of FIG. 12.

FIG. 15 is a top plan view of the socket support disc of this alternate embodiment, using frame using parts from the frame kit of FIG. 12.

FIG. 16 is a crossectional view of the support disc of FIG. 15, when viewed along crossectional line “16-16” of FIG. 15 using frame using parts from the frame kit of FIG. 12.

FIG. 17 is a side view in partial crossectional showing the attachment of a leg with a frame on one end and the socket support disc at the opposite end using frame using parts from the frame kit of FIG. 12.

FIG. 18 is a perspective view of the parts of FIG. 17 from another viewpoint using frame using parts from the frame kit of FIG. 12.

FIG. 19 is a perspective close-up detail view of a leg end, showing the tapered dovetail attachment slot.

FIG. 20 is a flow chart of the assembly of an illuminated display unit (IDU), including alternate embodiments with a multi-part support rim/frame with a plurality of attachable legs.

FIG. 21 is a side elevation of a hanging illuminated display unit (IDU) with legs pointing down and positioned between support and plain frame.

FIG. 22 is a side elevation of a pedestal supported illuminated display unit (IDU) with legs pointing upward and positioned between support and plain frame.

FIG. 23 is a perspective view of the separate parts of a further alternative frame kit with three legs.

FIG. 24 is a perspective view of an assembled support frame using parts from the frame kit of FIG. 23.

FIG. 25 depicts a leg using the alternate system attachment and configured in an asymmetrical vee.

FIG. 26 is a top plan view of a socket support disc in this embodiment.

FIG. 27 is a top plan view of the attachment slot on two alternative rim/frame shapes for this embodiment.

### DETAILED DESCRIPTION OF THE INVENTION

The present invention has broad applications to many fields for a variety of articles. For illustrative purposes only, a preferred mode for carrying out the invention is described herein.

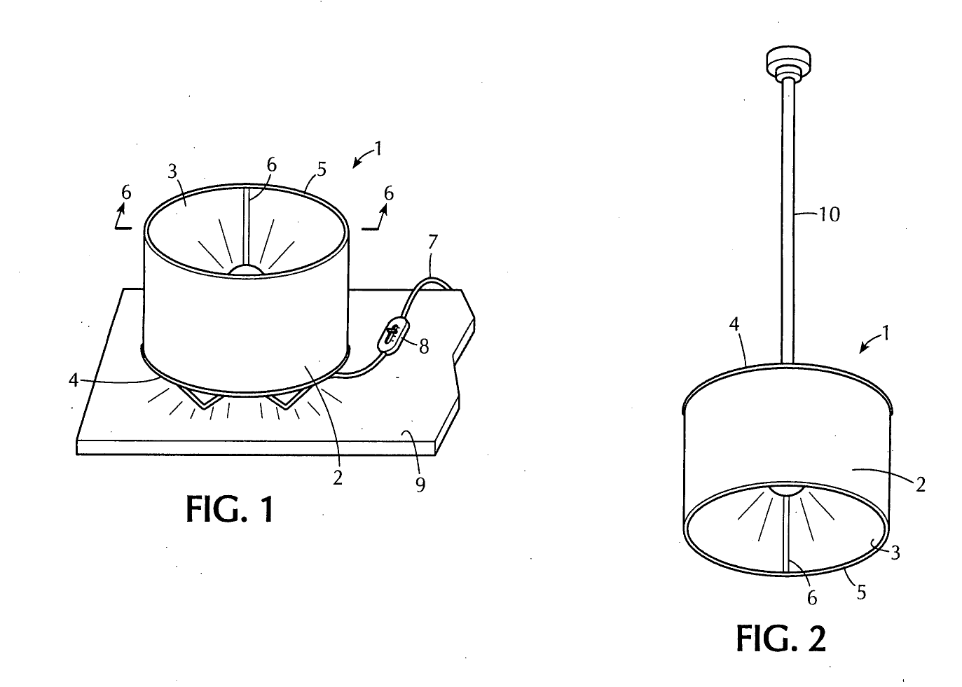

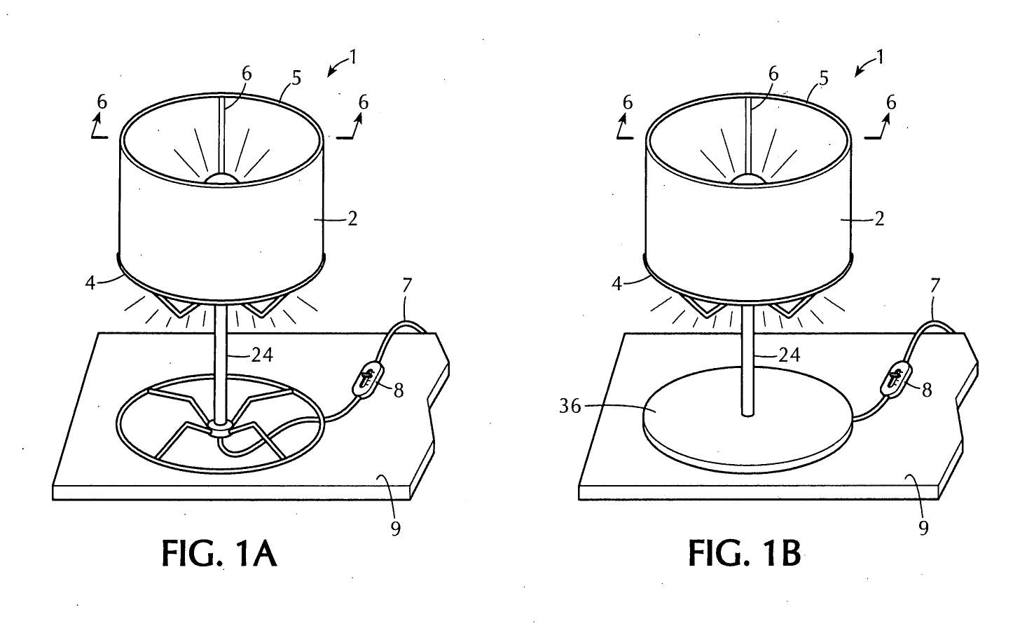

FIG. 1 shows a table top 9 on which illuminated display unit (IDU) 1 with art sheet 3 displaying art image 2 rests. Art sheet 3 is contained and shaped between support frame 4 at the bottom edge incorporating support legs facing down and plain frame 5 at top edge. A small overlap 6 of the free ends is at the rear of the display unit. Electrical control (switch or switch/dimmer) 8 is shown on electrical line 7.

FIG. 1A is a similar image of the same IDU 1 but with a pedestal tube and second support frame added at the base, wherein the support legs extend upward within the region surrounded by art sheet 3 of the illuminated display unit (IDU) 1.

FIG. 1B is a similar image of the same IDU 1 but with a pedestal tube and with a modified base, also wherein the support legs extend upward within the region surrounded by art sheet 3 of the illuminated display unit (IDU) 1.

FIG. 2 is a similar image of the same IDU 1 configured for hanging from pulley cord with support legs at the top 10.

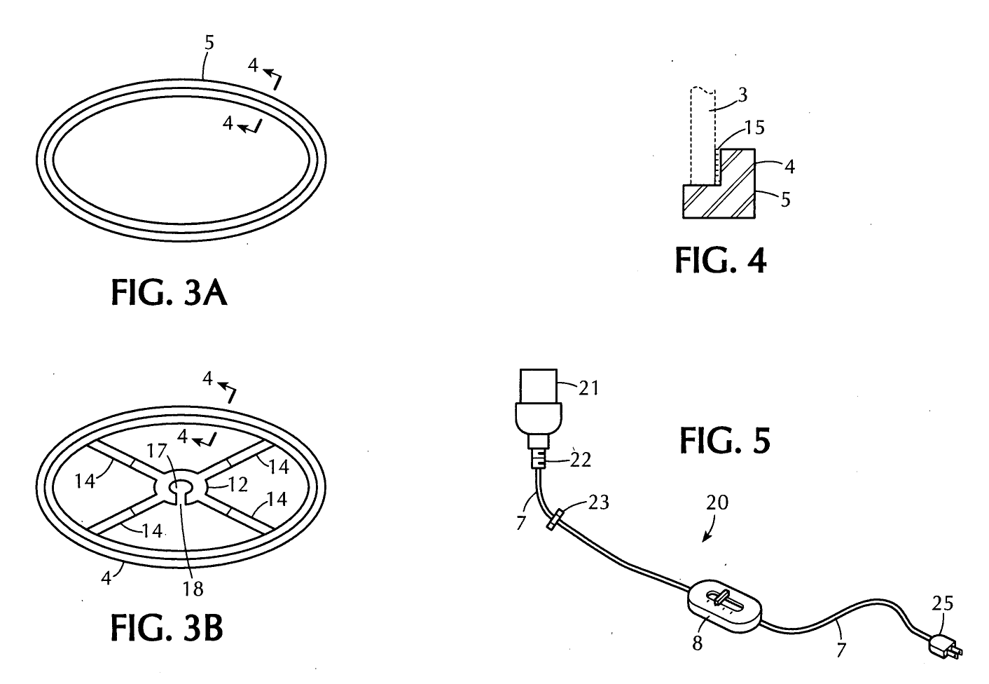

FIGS. 3A and 3B show the two part frame. The plain frame 5 is an oval shape. The support frame 4 is also oval but incorporates four legs (drawn flat) 14 leading at the center to a hub, such as a lamp socket support disc 12 with a central hole for the socket nipple 17 and a side slot for electric wire insertion 18.

Each of the art sheet support edges of the frames in this illustration have a preferably L-shaped crossection (see FIG. 4) which supports a top or bottom edge of art sheet 3. These supports also have a layer of tape attached with a release liner 15. The release liner can be removed prior to assembly to expose an adhesive layer for permanent attachment of the art sheet to the frame. This is optional for the table top unit where gravity holds the art sheet to the support frame 4 and to the plain frame 5. For the hanging configuration where gravity tends to pull the three sections apart, the adhesive layer 15 must be exposed and used.

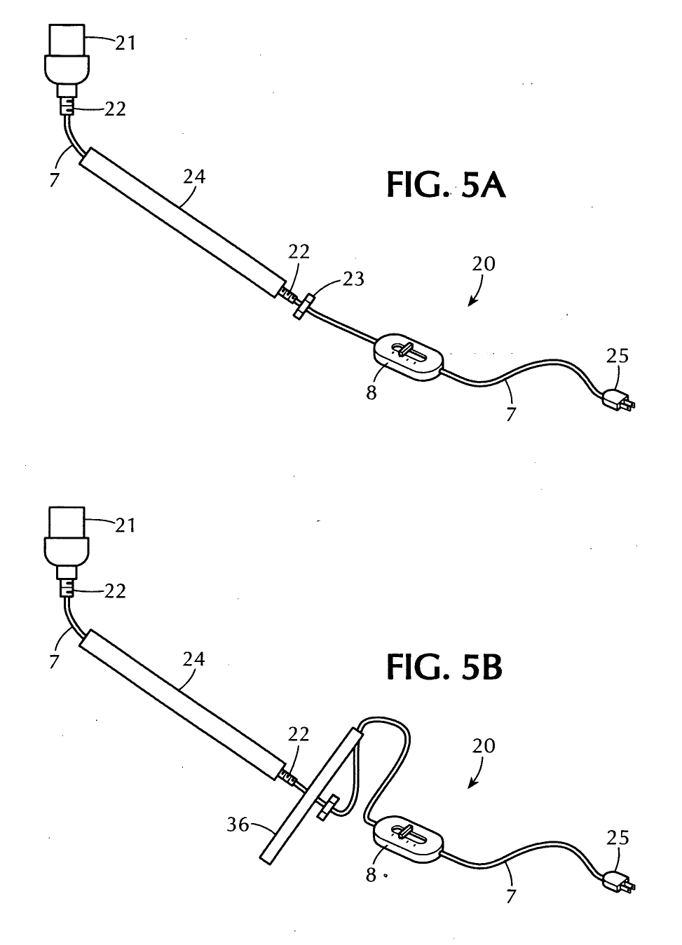

FIG. 5 shows a pre-wired electrical set for the table top model 20 consisting of lamp socket 21 with pre-attached short threaded nipple 22, nut 23, control 8, extension cord 7, and wall plug 25. Line cord 7 fits through slot 18 on socket support disc 12 which then permits short threaded nipple 22 to fit through the center hole 17 for attachment even though the entire electrical set is pre-wired.

FIG. 5A shows a pre-wired electrical set for the pedestal model 20 consisting of lamp socket 21 with pre-attached short threaded nipple 22, tube with internal threads to fit nipples at both ends 24, with pre-attached short threaded nipple at the end opposite the lamp socket 22, nut 23, control 8, extension cord 7, and wall plug 25. Line cord 7 fits through slot 18 on socket support disc 12 which then permits short threaded nipple 22 to fit through the center hole 17 for attachment even though the entire electrical set is pre-wired.

FIG. 5B shows the same electrical set as 5A but with a modified base unit 36 on line cord 7.

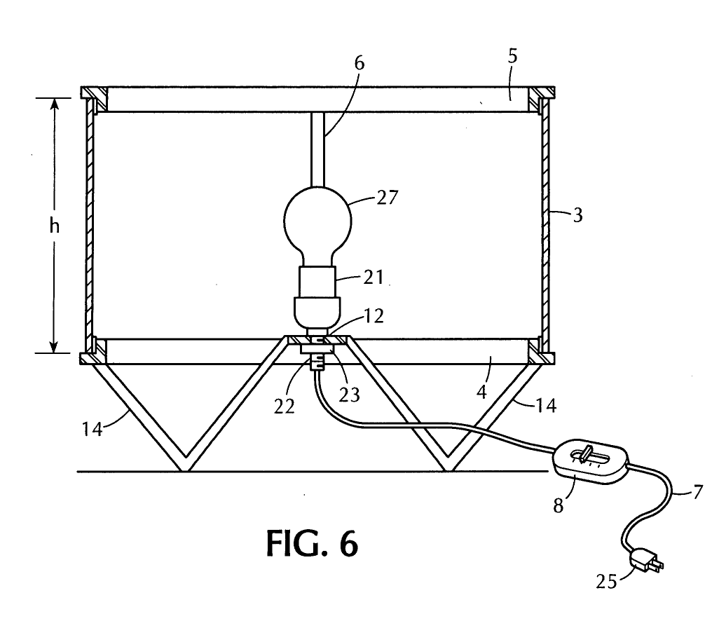

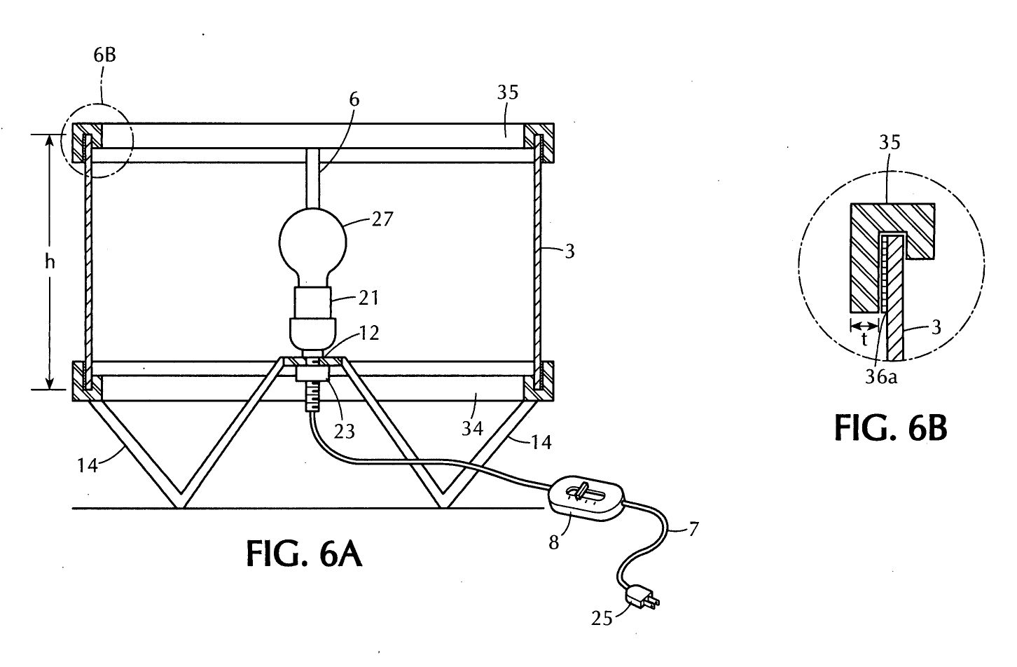

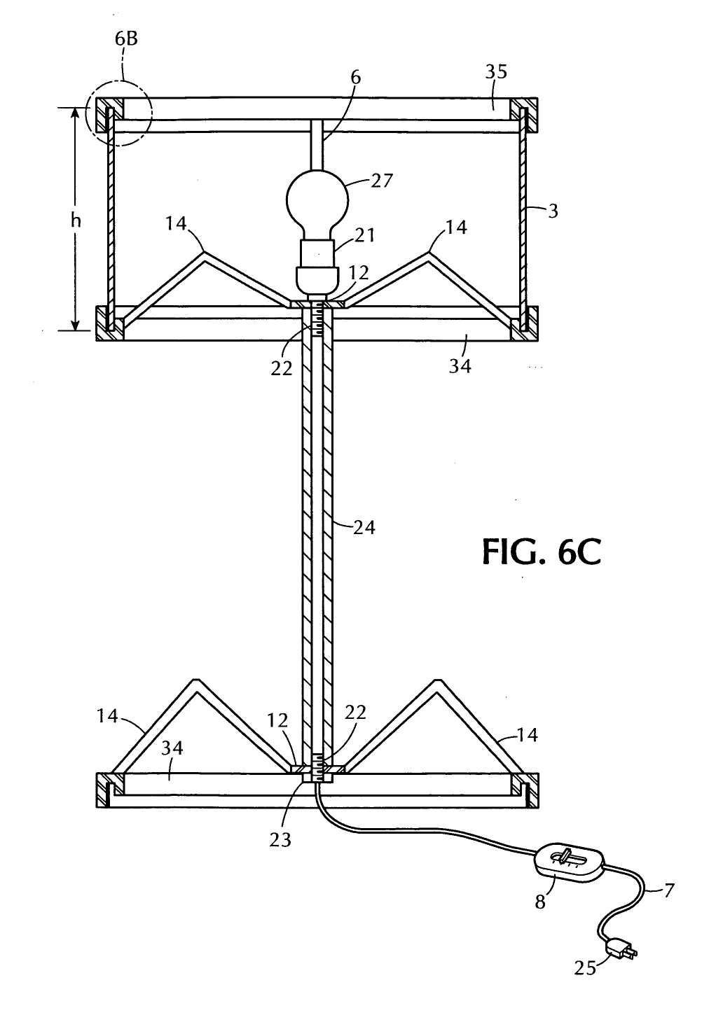

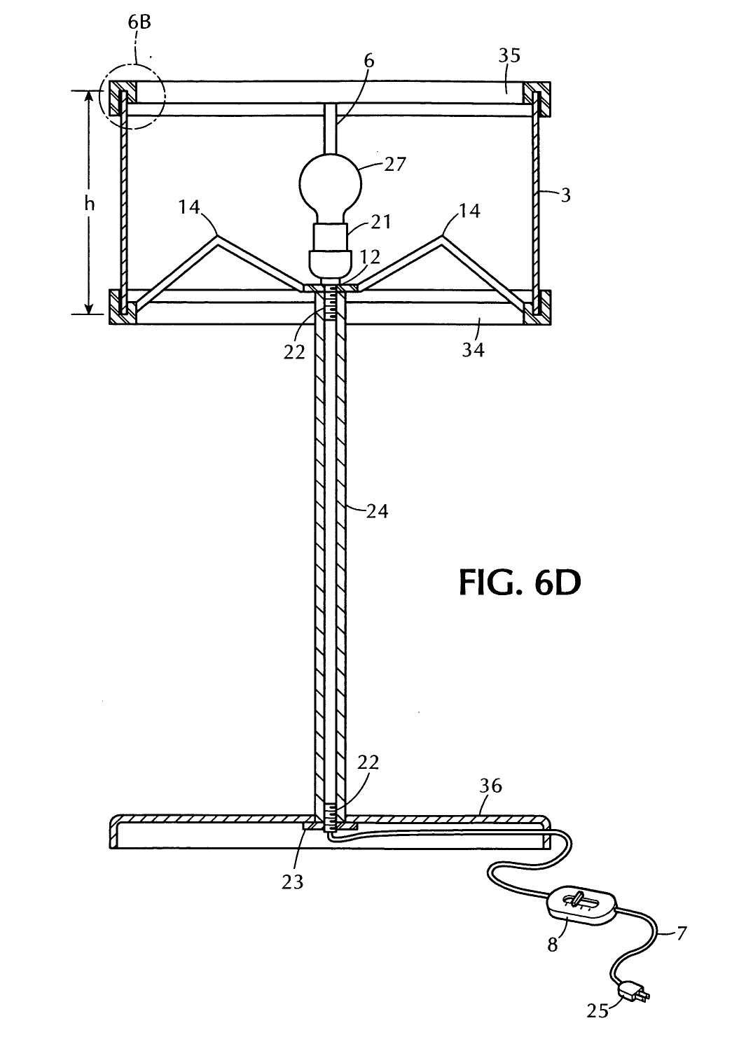

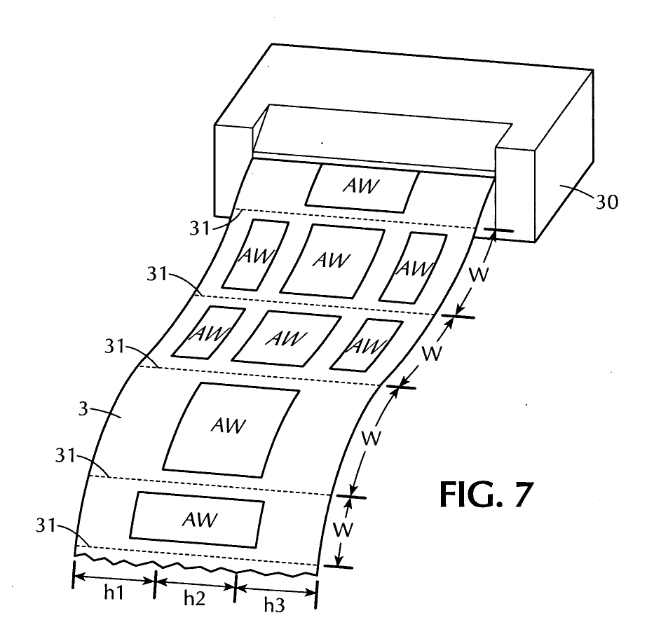

FIG. 6 shows how the various parts fit together for the table top model; bulb 7 (or optional CFL) is not part of the electrical kit because of fragility concerns. Note that legs 14 on support frame 4 bend down to create integral legs. The preferred fabrication of both frame parts is injection molding using a glass filled polycarbonate resin. In this illustration the support frame 4 would be formed as a single piece.

FIG. 6A shows an alternate embodiment of an illuminated table top model display unit (IDU) using another design of a support edge with an outer support lip on plain frame 35 and support frame 34. The detail of FIG. 6B shows how such an edge engages art sheet 3 at top edge. Note that double-sided tape with release liner 36a may be attached to art sheet 3 or to the frame edge is in either design. Frame edge material thickness T is nominally EDM 3/32″ with other dimensions relatively scaled.

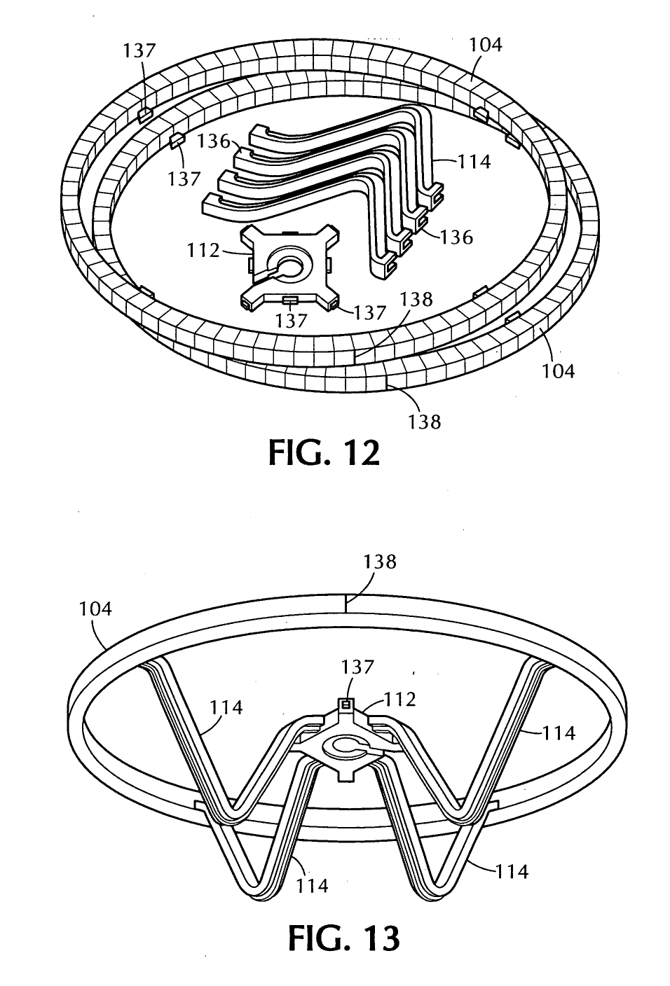

FIG. 6C shows a pedestal model illuminated art display unit (IDU) which provides a pedestal between the art display unit and a table top. This shows how the pedestal tube internally threaded at both ends 24 screws on to the short threaded nipple 22 on the lamp socket 21 and at the other end on to a second short nipple 22 which is inserted into center disc 12 on a second support frame 34, positioned upside down, and held in place by nut 23. Legs 14 are shown extending upward within the region surrounded by art sheet 3 which would be possible if the support frame parts are provided separately for customer assembly as described on a later page later herein concerning FIGS. 12-27.

FIG. 6D shows the modified base 36 illustrated in FIG. 1A, which assembles in same manner as the parts in FIG. 6C but must be provided pre-threaded on the electric wire as part of the electric kit because it does not have the unique slot provided for wire insertion that is on the support frame 34. Legs 14 are shown optionally extending upward within the region surrounded by art sheet. Electric cord 7 preferably exits out through a hole in base 36.

FIG. 7 shows a printer, such as a wide format printer 30, spewing out a long sheet of art sheet material which will be sliced at dashed lines 31 to form individual strips (all of the same circumferences length “W”) which will become art sheets 3 displaying art work “AW” after cutting into separate units. Note the heights of the different art sheets (h1, h2, h3) varies with the particular AW being printed since they are determined by the programmed instructions to the printer and are therefore infinitely variable. However, any printer capable of printing an image upon a flexible translucent or transparent sheet of plastic may be used, wherein one or more images may be printed on the flexible sheet of plastic, such as, for example, styrene manufactured by Primex Plastics Corporation.

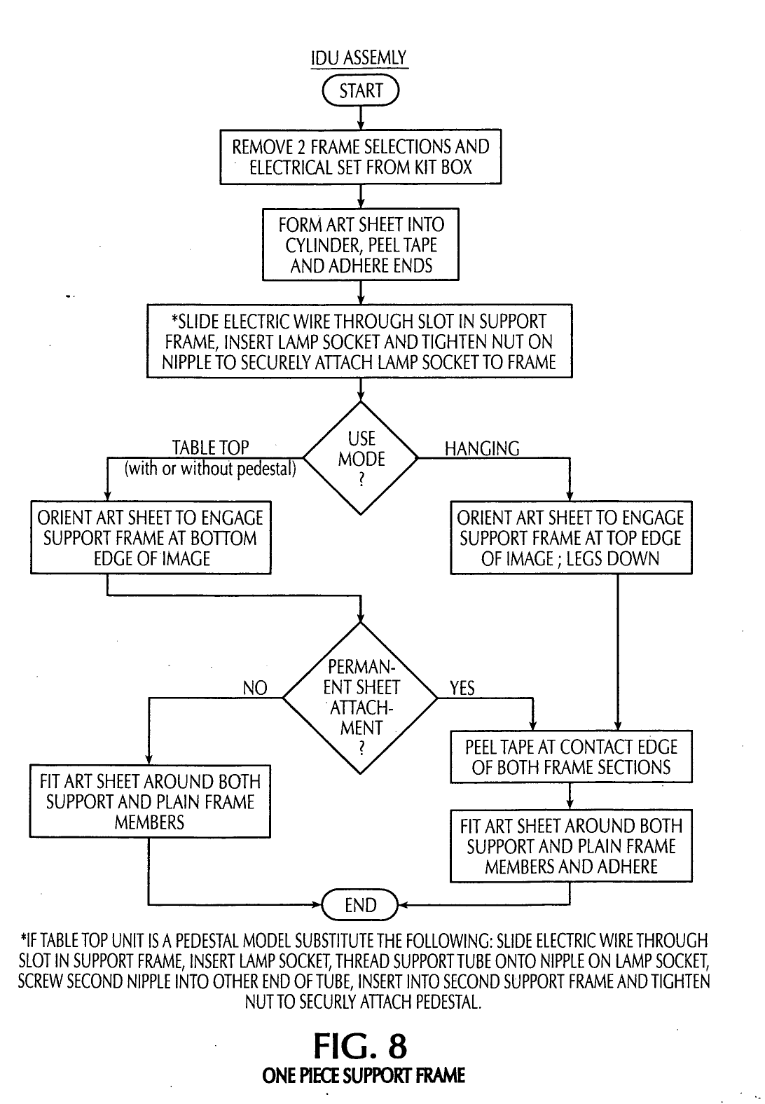

The IDU assembly flow chart of FIG. 8 is largely self-explanatory. Note that the orientation of the art to the support frame is different depending on whether a table top, pedestal or hanging version of IDU 1 is being assembled; this can be easily seen in FIGS. 1 and 2. Although permanent or temporary assembly is an option for a table top unit, the hanging version must be bonded together with the tape around the edge of the frame sections. Temporary assembly of the table top unit permits using the same frame kit serially for a variety of art sheet displays.

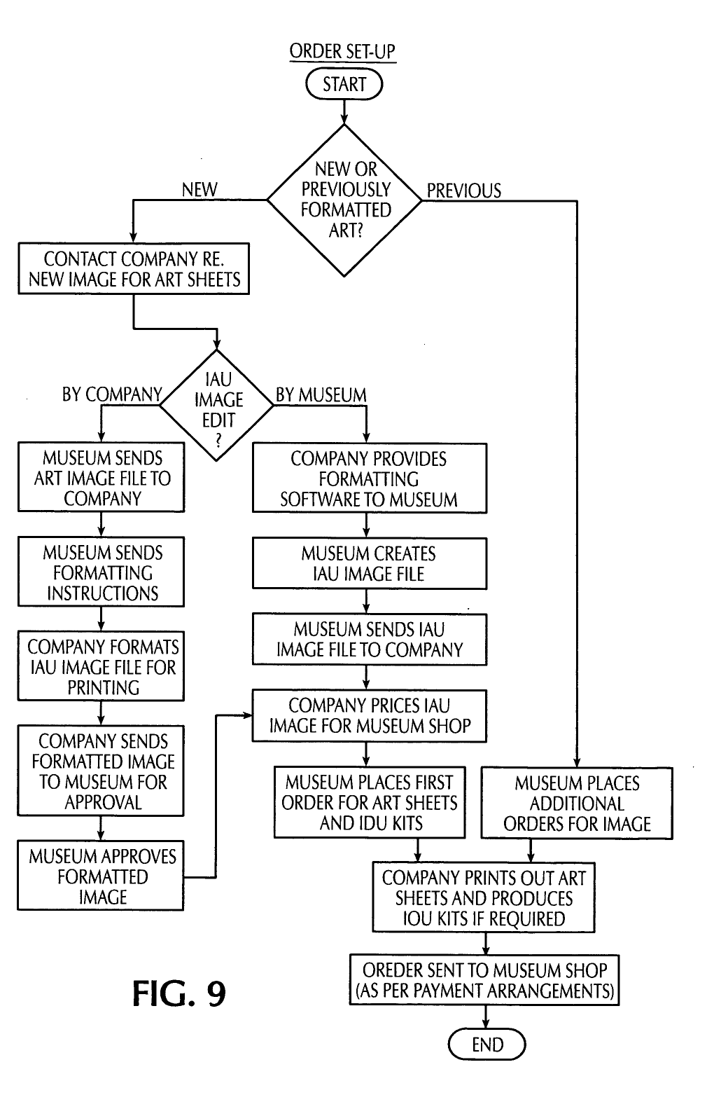

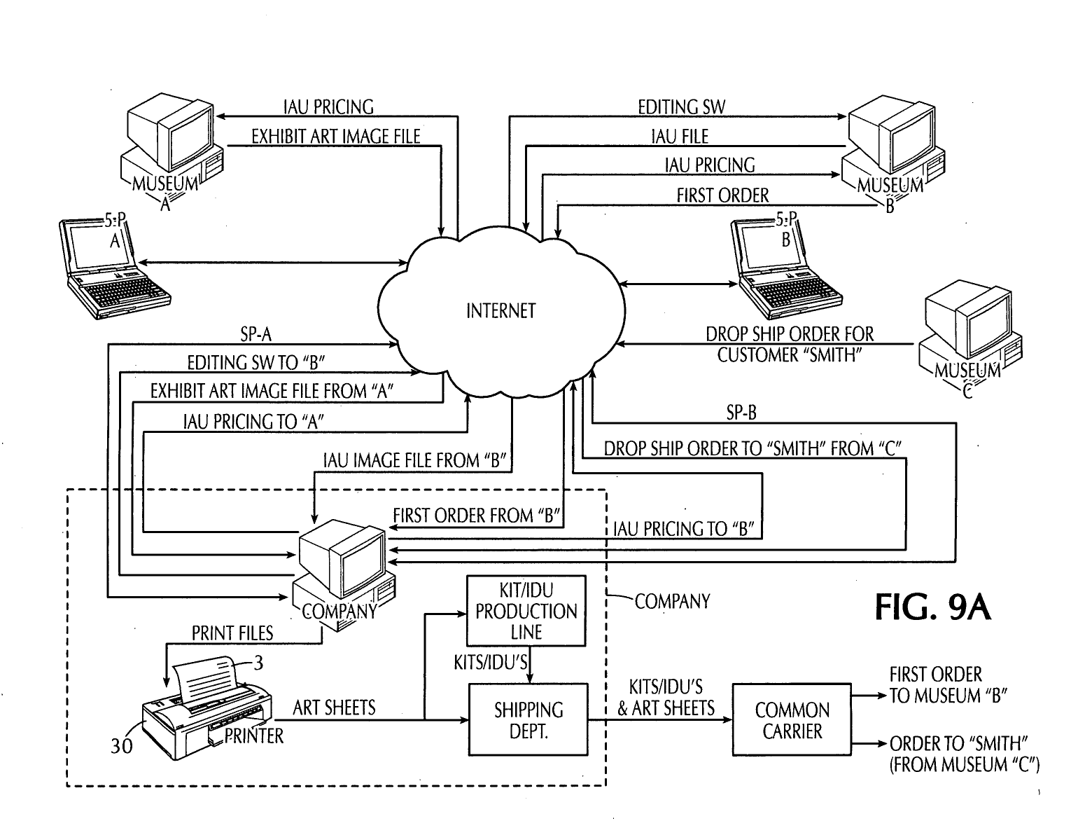

The process for the initial and subsequent order set-up with a museum gift shop was described in words in the summary section. FIG. 9 shows this process in flow chart form. This shows the optional methods of performing the formatting of the museum Exhibit Image File to create and Image Art Unit file of final digitized images that actually drive the printer to print out art sheets. The accurate pricing of each art sheet can only be performed after this step.

The flow chart of FIG. 9A clearly illustrates the computer hardware and network entities involved in actually implementing the order process. The box labeled “Company” in FIG. 9A includes a computer system including a central processing unit (CPU) or microprocessor facilitating communications enabled by a server through the internet between the company and three different museum gift shops is shown. Museums A and B are involved in initial order set-up, but museum A lets the company edit their exhibit art image file while Museum B edits their own exhibit art image file to an IAU file using software provided by the company. In both cases, IAU pricing is provided by the company. Museum C sends a drop shop order to the company for a customer named “Smith”. Both IDU kits as well as fully assembled IDU's with attached art sheets can be shipped out. The company keeps up with the museum interaction with its computer and microprocessor throughout the internet. Field representatives or company sales persons (as represented by “laptops” SP-A and SP-B) can also be used to send in orders resulting from museum gift shop visits or other communications. FIG. 9A also indicates how the company with its computer CPU or microprocessor creates , the art sheets on printer 30 and produces kits from an internal production line (as shown). Electric/frame kits and art sheets, or fully assembled IDU's, are shipped by a common carrier to the museum shops or to specific “drop ship” museum customers.

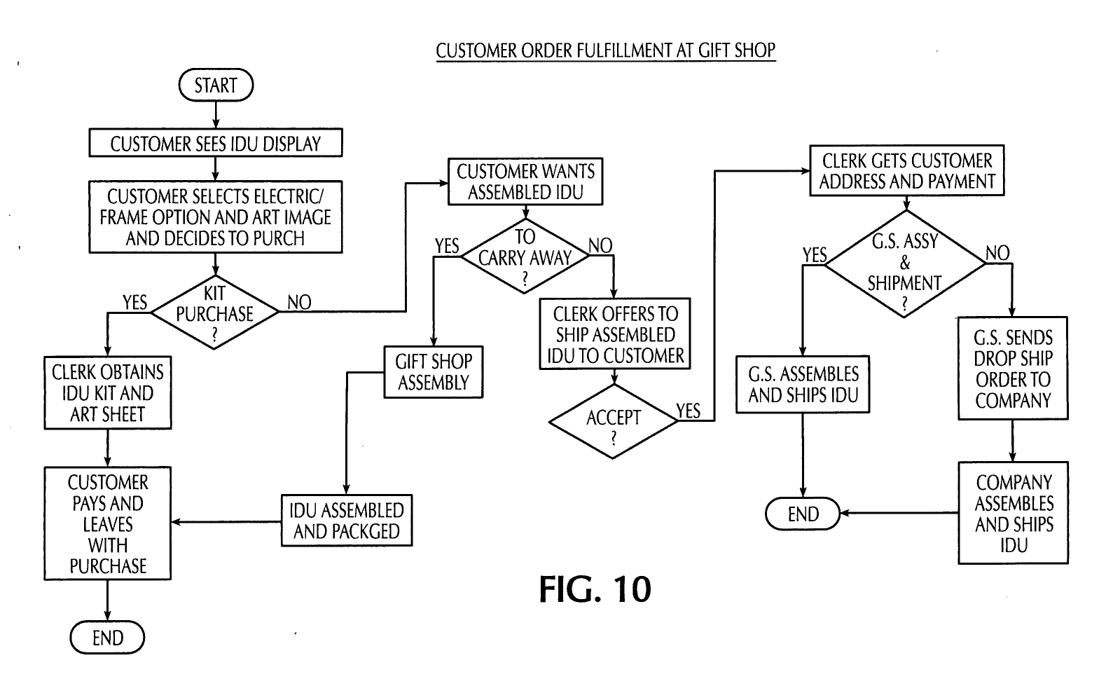

The different customer order fulfillment options discussed above in the summary are detailed in the flow chart of FIG. 10.

Although the main objective of this invention is to create an efficient method of displaying art that may be purchased at a museum shop, many other uses for an IDU unrelated to museums or fine art exist. One is a direct internet to customer marketing method whereby the “artwork” (which may, for instance, consist of family or travel snapshots) is provided by the customer for creating an art sheet. Another possibility is advertising use of IDU's such as displays promoting a certain brand of beer at a tavern. Another is artwork depicting local tourist attractions for sale in souvenir shops. The oval format described may not be optimal for theses unrelated applications. It is possible to use the identical manufacturing steps to create IDU's of any cylindrical crossection by using frames that have an alternate peripheral shape.

While intended use is to illuminate the translucent art sheet, under ambient light the art sheet still displays the art work image thereon.

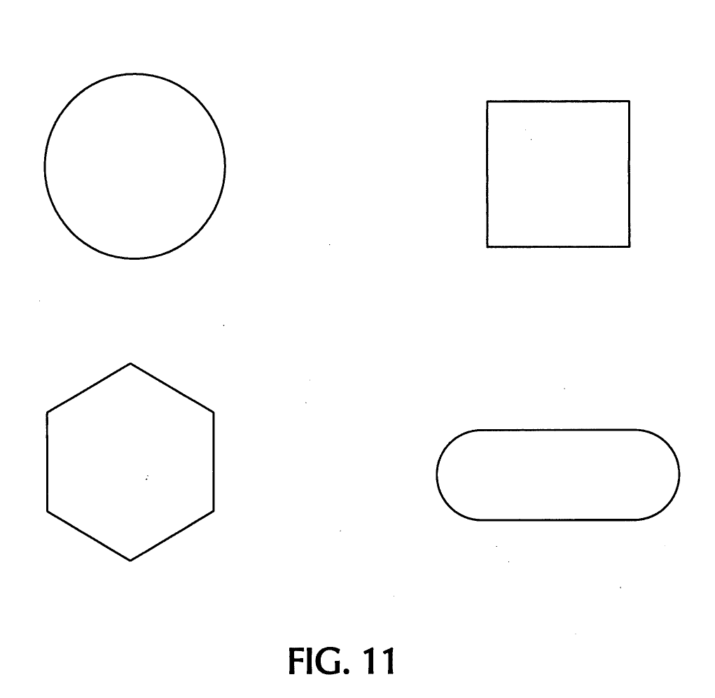

FIG. 11 schematically shows four examples of alternative top outline views of an IDU. They are drawn at the same scale to show the relative feature size for a constant circumference. The circle and oblong shapes would be easily produced, while the sharp corners of the square and hexagonal shapes would be somewhat rounded in practice to prevent creasing of the art sheet. The shape can be applicable to any shaped polygon, such as hexagonal or pentagonal, etc.

The parts comprising a frame kit of an illuminated display unit (IDU) of the alternate embodiment are shown in FIG. 12. Two plain frames 104 with art sheet alignment marks on the outside 138, and leg attachment lugs 137 in the inside, a plurality of legs, such as, for example, four legs 114, with a coupling at each end, such as, for example, a tapered dovetail coupling slot feature 136 at each end, and a lamp socket support disc 112 are included. For this example cooperative couplings, such as, for example, protruding lugs 137, are located on the inside of each plain frame 104 and on the outer surfaces of socket support disc 112, and the lugs 137 fit into the couplings in this example tapered slots at the leg ends 136. It is further noted that other configurations for the hub may be provided, so long as it is capable of holding the light source within the confines of the formed art sheet held in place by the support frame and the plain frame, wherein further the hub is connected to the support frame by a plurality of legs or spokes.

FIG. 13 shows such an assembled support frame with the legs 114 down. Note that the inner lugs 137 on disc 112 are used; a different shape of frame may require the use of the outer lugs 137 on disc 112.

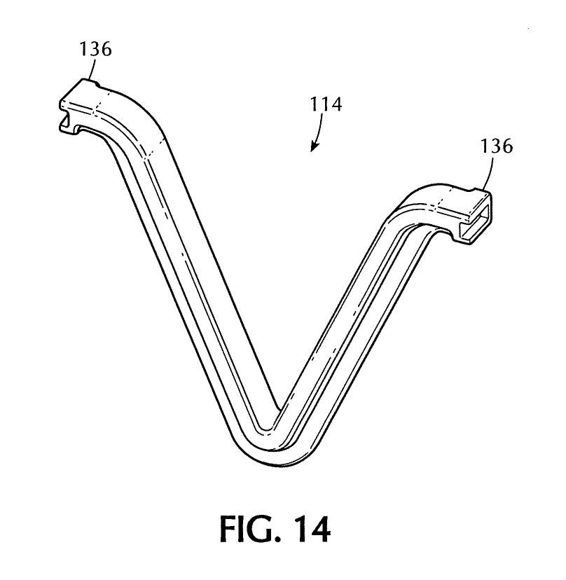

FIG. 14 provides a clear view of a single, preferably V-shaped leg 114 with preferably slotted leg ends 136. In this case the V is asymmetrical.

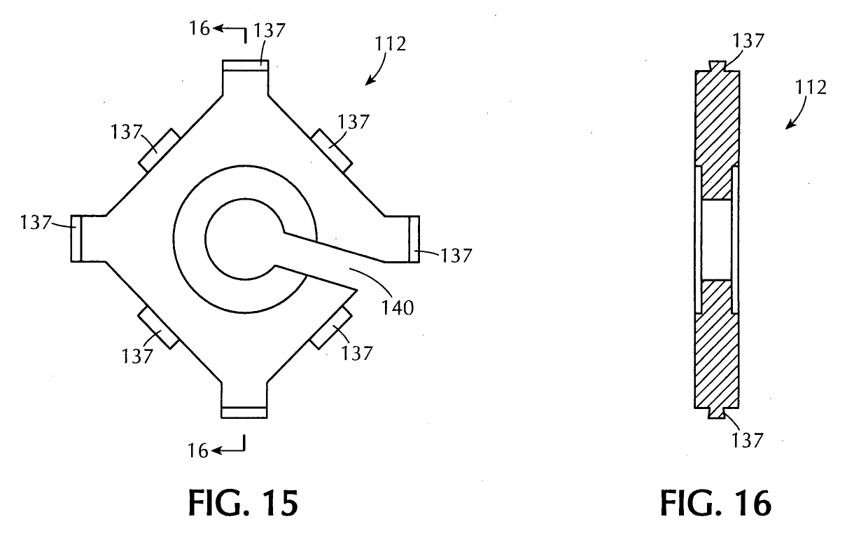

FIGS. 15 and 16 show details of lamp socket support disc 112 including lugs 137 and electrical wire access slot 140. That is one of the parts illustrated in FIG. 12.

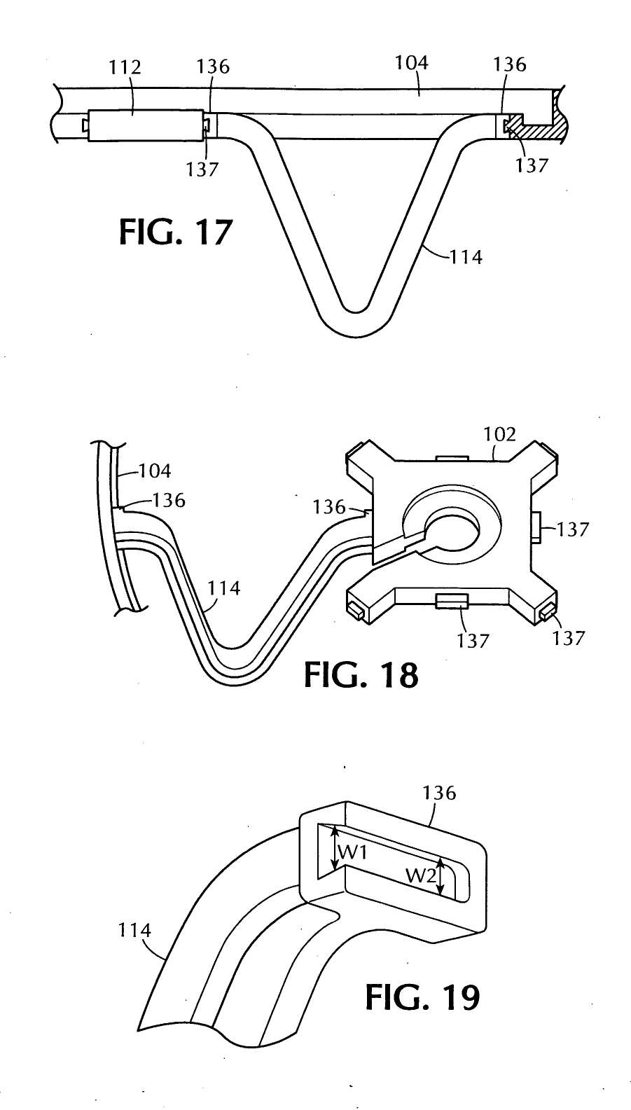

FIGS. 17-19 show details of an attachment system for the parts illustrated in FIG. 12 for the couplings associated with legs 114. For example, FIG. 17 is a side view showing the fit of couplings such as lugs 137 within cooperative couplings, such as slots, in ends 136. FIG. 18 is a perspective view showing a similar attachment. FIG. 19 shows an enlarged leg end 136. The tapered dovetail slot (note width “w1” greater than width “w2”) is shown clearly. Tapered dovetail lugs 137 are sized so that they will engage the inner walls of the slot in 136 at the mid slot position to lock the two members together.

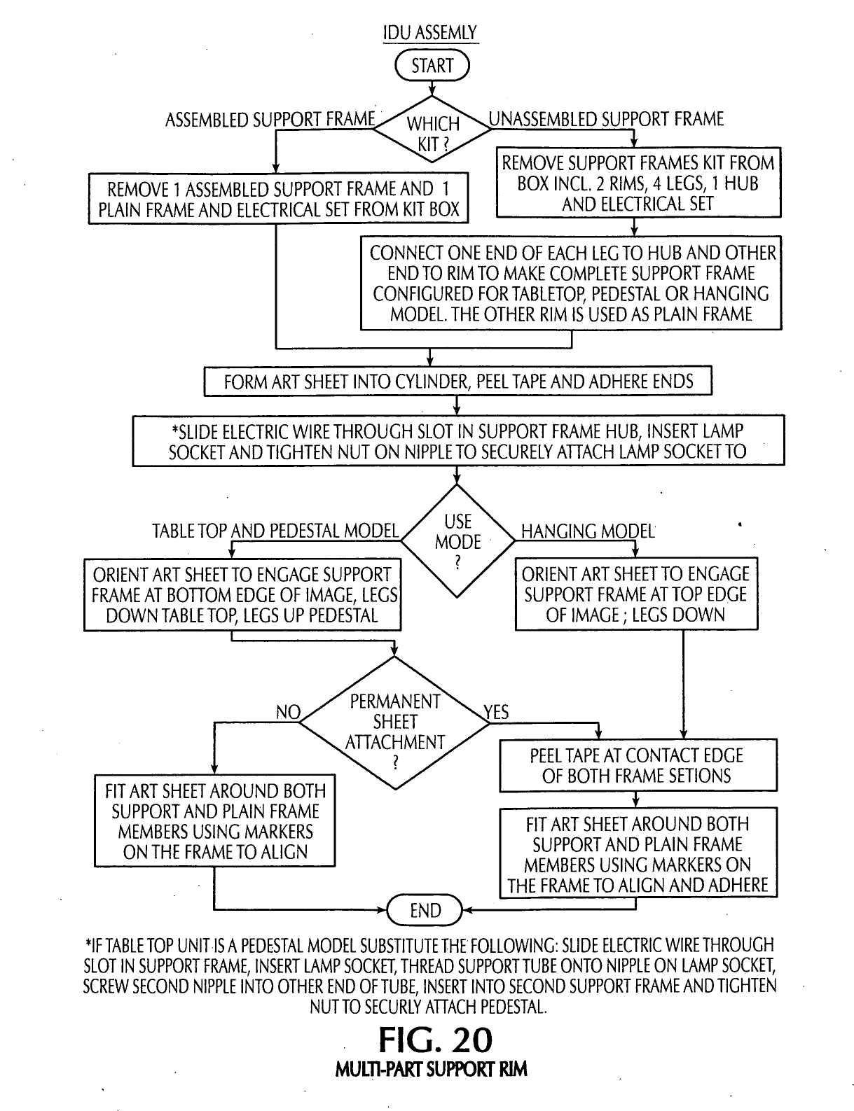

The flow chart of IDU assembly of FIG. 20 contrasts the assembly of the previous embodiment with the one-piece molded support frame shown in FIGS. 1-11 with that of the unassembled frame kit of the alternate embodiment of FIGS. 12-26. The entire difference in procedure involves the removal of the kit parts from the box and the assembly of the support frame by connecting each leg to the rim of a plain frame and to the lamp socket support disc (hub) while being aware of the desired configuration. From there on, the procedure is substantially identical to that of the previous embodiment, including the production of FIG. 7 as well as the assembly and organizational computerized flow charts of FIGS. 9, 9A and 10 and the schematic view of possible shapes shown in FIG. 11.

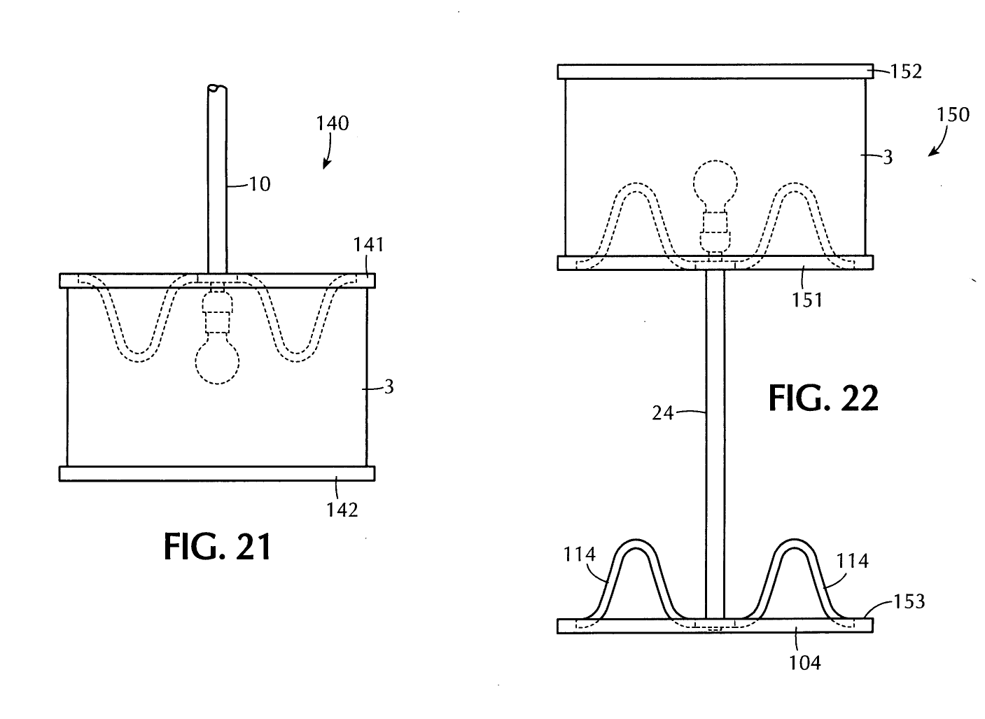

FIGS. 21 and 22 illustrate illuminated display unit (IDU) configurations that are not possible with the original one-piece molded support frame. A tabletop configuration using the support frame kit of this embodiment would be configured as in the original embodiment (support frame faces up with legs down); in fact FIG. 2 from the original embodiment is a good representation of it.

In FIG. 21, hanging illuminated display unit (IDU) 140 is configured such that support frame 141 is assembled with the support groove for art sheet 3 on member 104 facing down, as are legs 114. Plain frame 141 is simply a member 104 with the groove for art sheet 3 facing upward. Note that legs 114 now reside between support frame 141 and plain frame 142. This orientation is not possible with the original one-piece support frame which included the legs pointing in the opposite direction. Legs, socket support disc and lamp are shown in dashed lines as obscured by art sheet 3.

FIG. 22 illustrates a pedestal lamp 150 where support frame 151 is assembled from a member 104 facing upward and legs 114 also pointing upward. Plain frame 152 is a member 104 facing downward. Again here it can be observed that legs are positioned between plain and support frames (see dashed lines). Base 153 is assembled from a member 104 facing down and legs 114 facing up with a socket support disc in the center. Alternatively, a modified base 136 can be used (as shown in FIG. 6D).

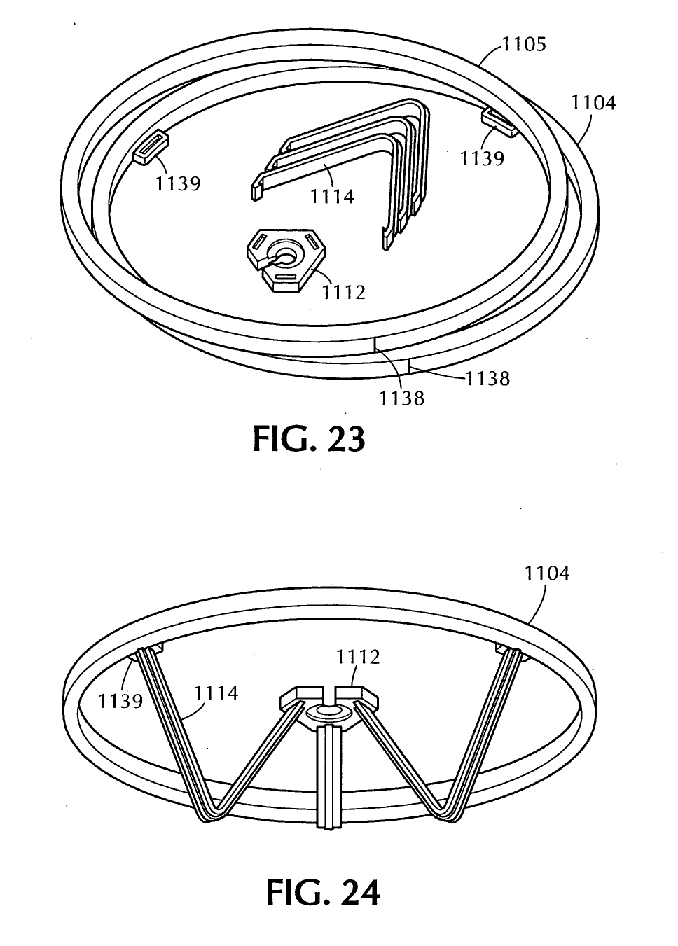

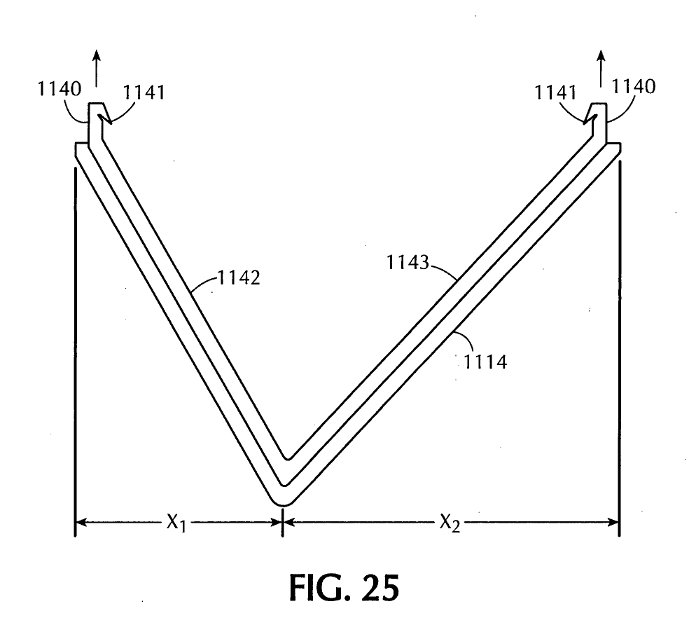

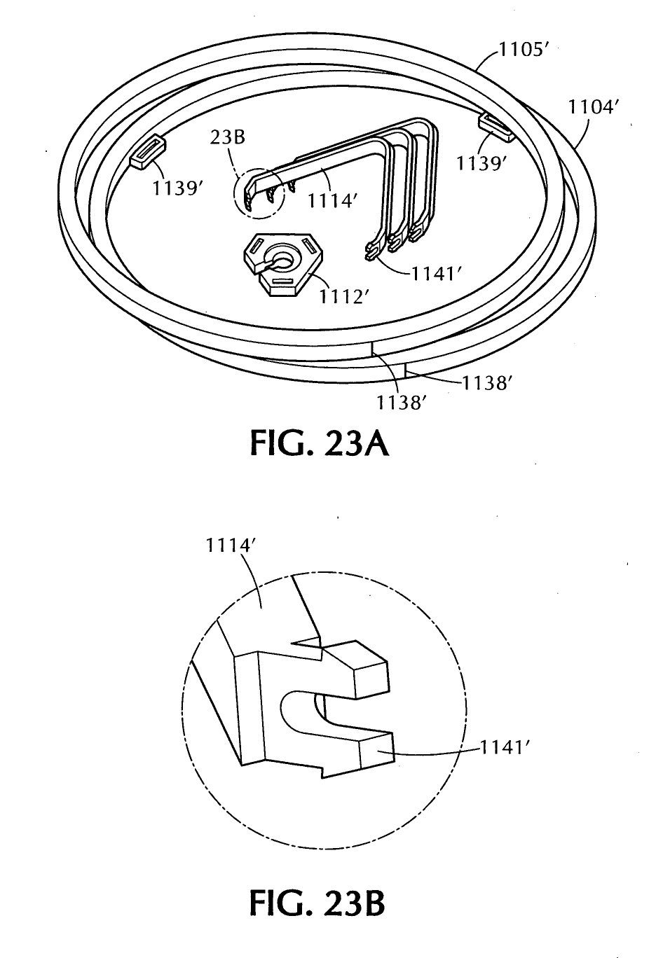

In yet, another embodiment shown in FIGS. 23 through 27, there are preferably three legs 1114 provided, and the attachment system of the legs 1114 to the hub frame 1104 and to the rim frame 1104 is changed to a tongue and slot system.

FIG. 23 shows the parts comprising of a frame kit of an illuminated display unit, (IDU) of this alternative embodiment. This embodiment includes one frame 1105 which does not have any provision for attachment of legs 1114 and another frame 1104 with such attachment provisions. The kit constitutes the two frames with sheet align marks on the outside 1138 and leg attachment slots 1139 on the inside, three legs 1114 with a coupling tongue at each end and a lamp socket support disc 1112 with slots for leg attachment of leg 1114.

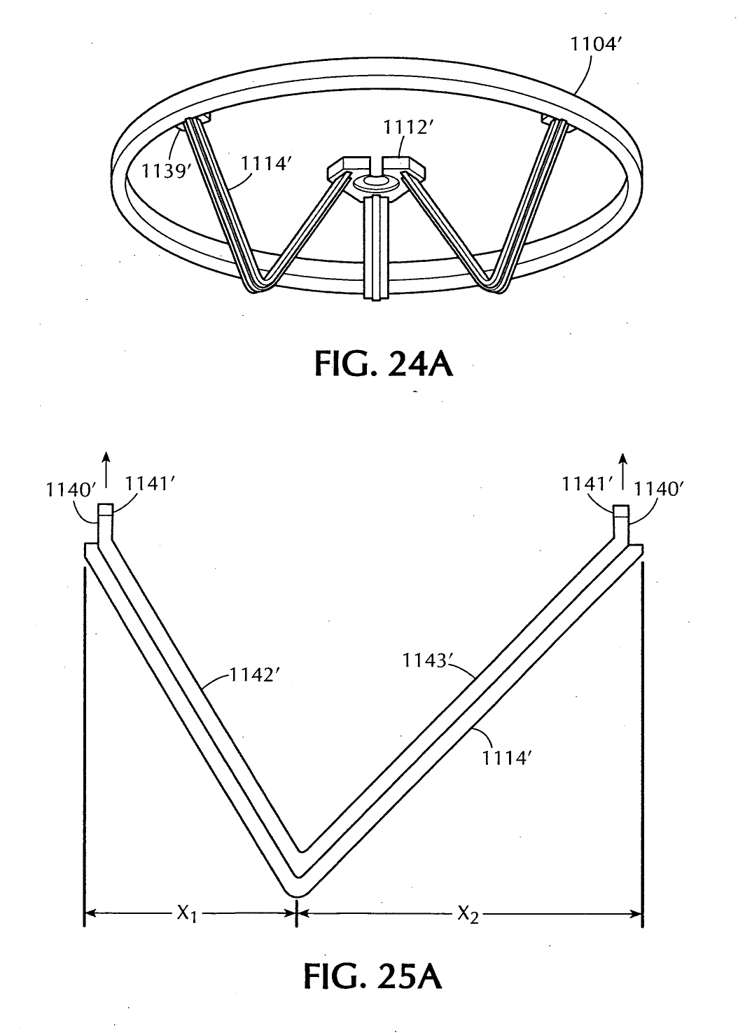

FIG. 24 shows the assembled support frame 1104 with legs 1114 and hub lamp support disc 1112 attached.

FIG. 25 shows one of the legs 1114 which is to enable the support of the unit to be spread farther apart now an asymmetrical “vee-shape” and the system for the system attachment for the leg 1114 to the hub lamp support disc 1112 and the frame 1104. The attachment details are shown clearly in this figure. Each leg 1114 has two attachment extensions 1140 at an angle to the angled leg portions 1142 and 1143 of each leg 1114. Extensions 1140 are angled vertically for insertion into and through slots or holes, such as for example, rectangular holes/slots 1139 in support frame 1104 and lamp support disc 1112. As extensions 1140 are pushed in toward the step region, molded cantilevered tongues 1141 are compressed until they again snap out locking extensions in slots or holes, such as for example, rectangular slots/holes 1139. The “Vee” shape of legs 1114 is preferably asymmetric to place the vertex closer to the edge (X1) than to the lamp support disc 1112 at the center (X2) affording better stability. Tongue 1140 has a cantilevered tip which is spring loaded, so that it compresses as tongue 1140 is inserted into leg attachment slot/hole 1139 and decompresses outward when through the slot/hole 1139, thereby locking leg 1114 in place in respective slots/holes 1139 in frame 1104 at one end and in lamp support disc 1112 at the other end.

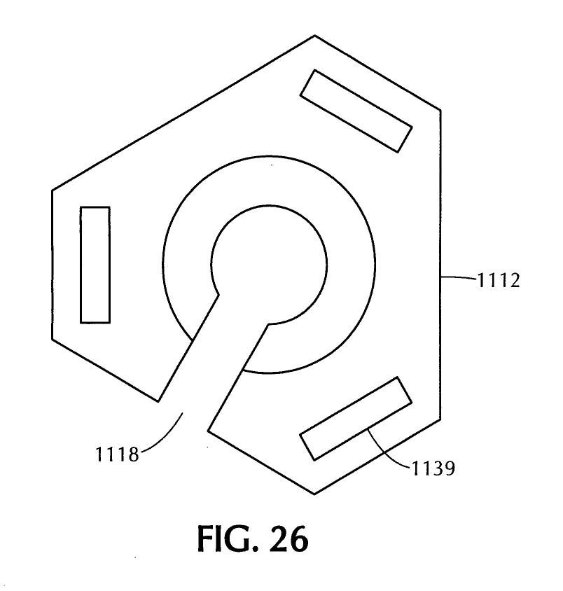

FIG. 26 shows details of the lamp socket support disc 1112 including leg attachment slots/holes 1139 and electrical wire access slot 1118.

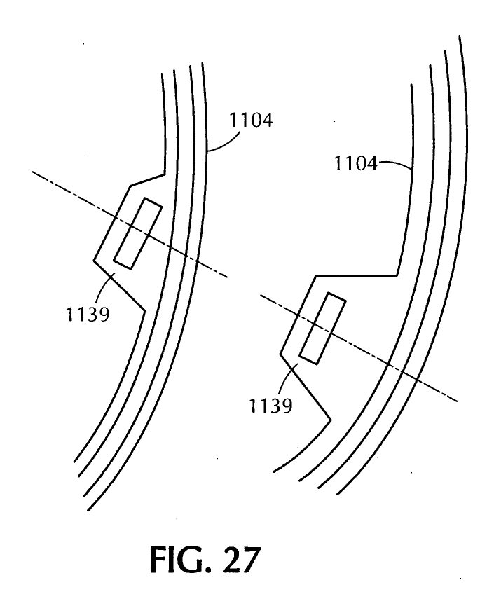

FIG. 27 shows examples of the leg attachment slots 1139 configured for a circular rim frame 1104 and an elliptical rim frame 1104. The slot on the circular rim frame 1104 is positioned a distance inside the rim frame 1104 to accommodate a leg of one size rims frames with a different radial difference from the hub lamp support disc 1112 to the rim/frame 1104.

While the foregoing illustrations depict a light source including a lamp with an AC socket and electrical cord connected to an AC power source, it is known that other light sources could be utilized, such as light emitting diode lamps, or DC powered lamps with DC power sources, such as batteries or other low voltage power sources.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only a, and are not meant to limit the scope of the present invention.

It is further known that other modifications may be made to the present invention, without departing the scope of the invention, as noted in the appended Claims.

1. An illuminated display unit comprising:
a pre-wired electrical set comprising of at least one of (a) a lamp socket with strain relief hooks and with a nipple, a nut, an attached pulley line cord, and a ceiling canopy unit at the distal end, or (b) a lamp socket with a nipple, a nut, an attached line cord, a lamp control, and a wall plug at the distal end, or (c) a lamp socket with a nipple, a tube internally threaded at both ends, a second nipple, a nut, an attached line cord, a lamp control and a wall plug at the distal end, or (d) a lamp socket with a nipple, a tube internally threaded at both ends, a second nipple, a lamp support base, a nut, an attached line cord, a lamp control and a wall plug at the distal end;
a custom made art sheet constructed of fabric pre-laminated to translucent plastic, said art sheet having a work of art or other image reproduced on a surface of said art sheet:
a plain frame in the form of a loop with a peripheral shoulder to engage an edge of said art sheet and guide said art sheet into a conforming closed shape around said plain frame;
a support frame with a loop member matching that of said plain frame to engage the edge of said art sheet distal to that engaged with said plain frame, said support frame also engageable with a plurality of separate attachable radially extending leg members having respective couplings attaching said loop member to a centrally located bulb socket support disc, said legs being capable of extending upward or downward;
said socket support disc having a hole dimensioned to accept said socket nipple with a peripheral slot of smaller width than said hole diameter to allow access to said line cord permitting locking of said lamp socket into said socket support disc by threading said nut onto an end of said nipple after insertion into said support disc.
said plurality of separate attachable radially extending members also bent into a generally V-shape thereby forming legs for table-top use support for/or hanging use while locating said lamp socket at the proper height for illumination of said art sheet.

2. The illuminated display unit of claim 1 further comprising
a second support frame acting as a base to support said illuminated display unit mounted on a pedestal tube for table-top use with a pedestal.

3. The illuminated display unit of claim 1 wherein said loops of said plain frame and said support frame are oval shaped.

4. The illuminated display unit of claim 1 in which said loops of said plain frame and said support frame loops are round shaped.

5. The illuminated display unit of claim 1 in which said loops of said plain frame and said support frame are rectangular shaped.

6. The illuminated display unit of claim 1 in which said loops of said plain frame and said support frame are oblong shaped.

7. The illuminated display unit of claim 1 in which said loops of said plain frame and said support frame are polygonal shaped.

8. The illuminated display unit of claim 1 wherein said peripheral shoulder of said loops of said frames is an L-shaped cross section or a U-shaped section with an adhesive layer covered by a release liner on the vertical section to permit selective attachment of said art sheet to said frames.

9. The illuminated display unit of claim 8 wherein said art sheet has a strip of adhesive covered by a release liner attached to one distal end to facilitate attachment of both free ends together by a slight overlap once said art sheet is formed into a closed form around said frame loops.

10. The illuminated display unit of claim 9 wherein assembly steps comprise attachment of said lamp socket of said pre-wired electrical set to said support frame, positioning of said art sheet around said peripheral shoulders of said frames, and removing said release liner at distal end of said art sheet to attach said free ends together with a slight overlap.

11. The assembled illuminated display unit of claim 10 wherein use as a table-top unit is completed by screwing a lamp into said lamp socket and supporting said unit on said legs on a horizontal surface and plugging into an electrical outlet.

12. The assembled illuminated display unit of claim 10 wherein use as a table-top unit is completed by screwing a lamp into said lamp socket and supporting said unit on a pedestal formed by a tube connecting said assembled illuminated display unit to a base resting on a horizontal surface and plugging into an electrical outlet.

13. The assembled illuminated display unit of claim 10 wherein use as a hanging unit also requires the steps of attachment of both top and bottom edges of said art sheet to both respective said frame loops, attaching the distal end of pulley cord, or similar tension support element, to a ceiling support and providing an electrical connection and screwing a lamp into said lamp socket.

14. The illuminated display unit of claim 1 wherein said couplings each comprise a respective slotted end of said respective leg engageable with a respective lug on said support frame.

15. The illuminated display unit of claim 1 wherein said couplings of said leg members each comprise a tongue with a bent cantilevered spring loaded tip compressible within a respective slot/hole in said support frame and within a respective slot in said lamp support disc, whereby each said tip decompresses upon completion of insertion in said slot/hole and locks said leg to said frame and said lamp support disc.

16. The illuminated display unit of claim 1 wherein each said leg is a symmetrical vee shape.

17. The illuminated display unit of claim 1 wherein each said leg is an asymmetrical vee shape.

18. A computer system for providing interchangeable illuminated displays for displaying art comprising:
a computer system having a microprocessor for implementing communications between a gift shop such as a museum gift shop or other institution or business and a company producing illuminated displays of images;
a database for receiving and storing data including museum art or other images, and lettering when required;
said database having data processing systems by which said gift shop and said company communicate, via a browser controlling communications over a network;
said computer system further comprising a server, wherein said gift shop and said company communicate with each other through said server;
wherein said company is formed to interact with said microprocessor of said computer system via the internet with corresponding computer systems having internet connections in respective gift shops in the production and sale of illuminated display units displaying high quality reproductions of art displayed at museum exhibits or other images;
said company receiving digital files depicting art objects from said gift shops;
said company producing art sheets from said files using high resolutions wide-format digital printers controlled by said microprocessor of said company computer;
said company using at least one of plastic art media or pre-laminated custom fabric/plastic art media to produce a set of interchangeable components for constructing an illuminated display unit holding and displaying one of said art sheets, said set of components comprising said art sheet being a flexible sheet of translucent material, said art sheet having a work of art or other image reproduced on a surface of said art sheet:
a plain frame in the form of a loop with a peripheral shoulder to engage an edge of said art sheet and guide said art sheet into a conforming closed shape around said plain frame;
a support frame with a loop member matching that of said plain frame to engage the edge of said art sheet distal to that engaged with said plain frame, said support frame also engageable with a plurality of radially extending leg members having respective couplings attaching said loop member to a centrally located light source support disc;
said light source support disc having a hole dimensioned to accept said light source, said plurality of radially extending members forming legs for table-top use while locating said light source at the proper height for illumination of said art sheet.
said legs being capable of extending upward or downward;
said company producing said illuminated display units compatible with the display of said art sheets;
said company using said microprocessor of said computer system for providing pricing of said art sheets and said illuminated display units to said gift shops and;
said gift shops marketing said art sheets and said illuminated display units to their respective customers.

19. A method of producing illuminated display units whereby said art sheets are produced in standard widths corresponding to the circumference requirements of the particular frame elements for which the art sheets are being printed, utilizing the art media capacity of a high resolution wide-format printer on which one or more art images are printed;
producing said art sheets in variable lengths to produce lengths,
wherein said art sheets are then cut apart to produce variable height images as required by the formatted art that has been printed;
providing said illuminated display units with respective frame elements of standard sizes to accommodate said art sheets of standard lengths as they are formed around the periphery of said frame elements thereby forming displays of constant circumference but which may be variable heights depending how each length is cut apart;
each said frame element comprising a loop engageable with a plurality of separable legs each having coupling elements at respective ends, one of said coupling elements of each said leg joinable with a cooperative coupling located a respective location on said frame element and another opposite coupling element on an opposite end of said respective leg joinable with an opposite cooperative coupling located on a centrally located socket support disc having a recess accommodating insertion of an electrical cord connectable with a light source illuminated said art sheet; and said legs being capable of extending upward or downward.

20. The computer system for displaying art as in claim 18 wherein said digital files of artwork are transferred over the internet.

21. The computer system for displaying art as in claim 18 wherein said digital files of artwork are transferred in a tangible digital media.

22. The computer system for displaying art as in claim 21 in which said tangible digital media is a DVD.

23. The computer system for displaying art as in claim 21 in which said tangible digital media is a portable document.

24. The computer system for displaying art as in claim 21 in which said tangible digital media is a scanned document.

25. The computer system for displaying art as in claim 21 in which said tangible digital media is a diskette.

26. The computer system for displaying art as in claim 21 in which said tangible digital media is a cellular communications media.

27. The computer system for displaying art as in claim 18 wherein said light source is an AC powered lamp socket supported by a light source support disc having a hole dimensioned to accept a socket nipple with a peripheral slot of smaller width than said hole diameter to allow access to said line cord permitting locking of said lamp socket into said socket support disc by threading a nut onto an end of said nipple after insertion into said support disc, said plurality of radially extending members also bent into a V-shape thereby forming legs while locating said lamp socket at the proper height for illumination of said art sheet; and said legs being capable of extending upward or downward.

28. The computer system for displaying art as in claim 27 further comprising:
said custom made pre-laminated art sheets being produced in standard widths corresponding to the circumference requirements of frame element being utilized, utilizing the media capacity of a high resolution wide-format printer on which art images are printed;
wherein said art sheets are then cut apart to produce variable height images corresponding to the circumference frame element being utilized;
wherein said illuminated display units include frame elements of standard sizes to accommodate said art sheets of standard lengths as they are formed around the periphery of said frame elements, thereby forming displays of constant circumference but of variable heights.

29. The computer system for displaying art as in claim 18 wherein said light source is a DC powered light source.

30. An illuminated display unit kit comprising:
a light source;
a plastic art sheet constructed of translucent plastic, said art sheet having a work of art or other image reproduced on a surface of said art sheet;
a plain frame in the form of a loop with a peripheral shoulder to engage an edge of said art sheet and guide said art sheet into a conforming closed shape around said plain frame;
a support frame with a loop member matching that of said plain frame to engage the edge of said art sheet distal to that engaged with said plain frame, said support frame also engageable with a plurality of separate radially extending leg members attaching said loop member to a centrally located light source support hub;
said light support hub holding said light source within the confines of said plastic art sheet being wrapped around end to end and held in place by said plain frame and said support frame;
said legs being capable of extending upward or downward;
said light source support hub having a hole dimensioned to accept said light source communicating with a power source;
said plurality of radially extending legs forming legs for table-top use support or for hanging use while locating said light source at the proper height for illumination of said art sheet.
